(19) United States
(12) Patent Application Publication
(10) Pub. No.: US 2005/0270912 A1
(43) Pub. Date: Dec. 8, 2005

(54) Optical pickup and apparatus for recording and/or reproducing optical recording medium

(75) Inventors: Katsutoshi Sato, Tokyo (JP); Hiroaki Yukawa, Kanagawa (JP); Kenji Yamamoto, Kanagawa (JP); Noriaki Nishi, Kanagawa (JP); Midori Kanaya, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 11/119,927

(22) Filed: May 3, 2005

(30) Foreign Application Priority Data
May 14, 2004 (JP) 2004-145646

(51) Int. Cl. G11B 7/00

(52) U.S. Cl. 369/44.11

(57) ABSTRACT

The present invention provides an optical pickup in which light beams of different wavelengths, radiated from plural light sources and reflected back from a recording surface, are condensed in the same area. The optical pickup records and/or reproduces each of a plurality of optical recording mediums having different protective substrate thicknesses, by light beams different in wavelength and in numerical aperture, and includes a light source including a first radiating part for radiating a first light beam having a first wavelength, a second radiating part for radiating a second light beam having a second wavelength, and a third radiating part for radiating a third light beam having a third wavelength, an objective lens for condensing said first to third light beams on each of the optical recording mediums having different protective substrate thicknesses, and a light receiving section for receiving light beams reflected by said optical recording mediums and converting the light beams into electrical signals, there being provided an optical axis combining section on an light path from a light source to said light receiving section for bringing the optical axes of reflected light beams of said first to third light beams into coincidence on a light receiving surface of said light receiving section.

The present invention contains subject matter related to Japanese Patent Application JP 2004-145646 filed in the Japanese Patent Office on May 14, 2004, the entire contents of which being incorporated herein by reference.

### BACKGROUND OF THE INVENTION

1. Field of the Invention

This invention relates to an optical system for recording and/or reproducing an optical recording medium and, more particularly, to an optical pickup and a recording and/or reproducing apparatus for an optical recording medium whereby write/readout operations may be carried out for plural recording mediums, using different recording and/or reproducing wavelengths.

2. Description of Related Art

Recently, there is raised a demand for a larger recording capacity of a recording medium, such as CD (Compact Disc), MD (Mini Disc) or DVD (Digital Versatile Disc), and a large variety of techniques have so far been devised in order to increase the capacity. There is also raised a demand that variegated data, such as music contents data, picture contents data or data for computers, can be freely recorded and/or reproduced for a sole recording medium. In particular, a novel disc format employing the laser light of a wavelength band of 405 nm, e.g. Blue-ray disc (BD), is stirring up notice as the next-generation recording technology.

In developing a universally employed recording medium, compatibility and matching between the recording and/or reproducing apparatus for new and state-of-the-art apparatus are critical, specifically, a newly developed recording and/or reproducing apparatus is desirably able to record and/or reproduce state-of-the-art resources, such as DVD or CD. It is however not easy to design an apparatus having compatibility between the recording mediums different in the disc structure and in the concomitant laser specifications.

The simplest method is to provide different optical systems and to switch plural dedicated objective lenses from one wavelength in use to another. However, in this case, a switching mechanism for switching the plural objective lenses is needed, thus raising the cost. Moreover, an actuator becoming bulky in size is deterrent to size reduction of the apparatus. For this reason, an optical system adapted for coping with plural wavelengths by co-owning part of the optical system, such as an objective lens, or a photodetector, is used.

As an example, a dual wavelength compatible optical system, designed to cope with the DVD (Digital Versatile Disc), employing the wavelength band of 655 nm, as recording and/or reproducing light, and with the CD (Compact Disc), employing the wavelength band of 655 nm, as recording and/or reproducing light, will now be explained. An optical pickup, employing a so-called double-wavelength laser diode, including a laser device, emitting two beams, arranged in a single package, represents a system in which optical axes of two laser light beams, emitted from different light radiating positions, are combined together such that light spots of light for two wavelengths, reflected from the recording surfaces of the optical disc, are confounded in a preset area of a sole light receiving device. For combining the optical axes of the laser light beams, such a method consisting in employing a stepped deflecting optical element (hologram device), having a stepped cross-sectional profile parallel to the axis of transmitting light, or a blade type deflecting optical element (hologram device) having a serrated shape, in a forward light path or a return light path, in order to combine two optical axes together, is customarily used (see Patent Publication 1, Japanese Laid-Open Patent Publication 2003-31302).

With the dual wavelength compatible type, it is possible to design a diffractive element which, by the combination of a certain curved surface of a lens and a diffractive element, with the degree of freedom equal to 2, will give an optimum value of two different thicknesses of the protective disc substrates and the recording and/or reproducing wavelengths, with the degree of freedom equal to 2, whereby the aforementioned problem may be resolved.

However, in the case of using a three wavelength laser diode, in which the aforementioned light source for the BD of the new format is arranged, along with the light sources for the DVD and the CD, it is difficult to combine the optical axes of the laser light beams together so that light spots of reflected light beams will be confounded in the same preset area, owing to the following two points:

The first problem is that the manner the three laser light sources are arrayed affects the combination of the optical axes. For example, with the stepped hologram device, the light beam can be diffracted a predetermined angle dependent on the wavelength of the incident light, and the transmitted light is radiated in a direction perpendicular to the plane of the device. However, the beam cannot be bent in a direction different from the direction of the wavelength dependent angle of diffraction. Thus, when the light sources are arranged on a straight line, there is the possibility of condensing the three light spots of reflected light in the same area, with the single stepped hologram device, even though under extremely limited conditions. However, if the design center positions of the light sources are arrayed on a transverse straight line, but the actual center positions are slightly deviated from the transverse straight line due to assembling errors produced during assembling, or if the assembling positions of the light sources are inherently offset from the transverse straight line, it is not possible to combine the optical axes of the light beams of different wavelengths.

The second problem arises from the fact that the wavelength of 780 nm used for recording and/or reproducing a CD is approximately twice the wavelength of 405 nm used for recording and/or reproducing a BD. With the laser light beam of the wavelength of 405 nm and with that of the waveform of 780 nm, the tendency is that the diffraction efficiency at a given order number of one or the other light beam elevates that at the same order number of the remaining light beam. Consequently, the two light beams may be diffracted at diffraction angles close to each other, thus interfering with the combining of three laser light beams.

If, in the three-wavelength compatible optical system, the light spots of reflected light beams cannot be condensed in the same area, plural light receiving units are needed. In case the optical axes cannot be combined on the forward light path until the outgoing laser light reaches the recording surface of the optical disc, it may occur that the aberration becomes severe under the influence of the off-axis characteristics of the lens present on the optical axis, or the light volume distribution suffers from offset, thus deteriorating optical characteristics of the optical pickup.

### SUMMARY OF THE INVENTION

In view of the above depicted status of the art, it is desirable to provide an optical pickup having an optical system capable of combining light spots of the recording and/or reproducing light beams of different wavelengths, generated from plural light sources, in the same area, and a recording and/or reproducing apparatus employing this optical pickup.

According to the present invention, there is provided an optical pickup for recording and/or reproducing each of a plurality of optical recording mediums having different protective substrate thicknesses, by light beams different in wavelength and in numerical aperture, the optical pickup including
a light source including a first radiating part for radiating a first light beam having a first wavelength, a second radiating part for radiating a second light beam having a second wavelength, and a third radiating part for radiating a third light beam having a third wavelength,
an objective lens for condensing the first to third light beams on each of the optical recording mediums having different protective substrate thicknesses, and
light receiving means for receiving light beams reflected by the optical recording mediums and converting the light beams into electrical signals,
there being provided optical axis combining means on an light path from a light source to the light receiving means for bringing the optical axes of reflected light beams of the first to third light beams into coincidence on a light receiving surface of the light receiving means.

According to the present invention, there is provided a recording and/or reproducing apparatus for an optical recording medium for rotationally driving each of a plurality of optical recording mediums having different protective substrate thicknesses, the apparatus including an optical pickup displaced along the radius of the optical recording mediums by feed means for carrying out recording and/or reproduction by a plurality of light beams having different wavelengths and numerical apertures depending on the sort of the optical recording mediums, the apparatus controlling the rotation of the optical recording mediums and the displacement of the optical pickup in keeping with the recording and/or reproducing operation, wherein the optical pickup includes
a light source including a first radiating part for radiating a first light beam having a first wavelength, a second radiating part for radiating a second light beam having a second wavelength, and a third radiating part for radiating a third light beam having a third wavelength mounted in proximity to one another;
an objective lens for condensing the first to third light beams on each of the optical recording mediums having different protective substrate thicknesses; and
light receiving means for receiving light beams reflected by the optical recording mediums and converting the light beams into electrical signals,
there being provided optical axis combining means on a light path from a light source to the light receiving means for bringing the optical axes of reflected light beams of the first to third light beams into coincidence on a light receiving surface of the light receiving means.

According to the present invention, there is provided an optical pickup for recording and/or reproducing a plurality of optical recording mediums, having different protective substrate thicknesses, using light beams having different wavelengths and numerical apertures, the optical pickup including
a light source for radiating a first light beam having a first wavelength, a second light beam having a second wavelength and a third light beam having a third wavelength, from different positions of a single package;
an objective lens for condensing the first to third light beams on the optical recording mediums having respective different protective substrate thicknesses; and
light receiving means for receiving the light beams reflected back from the respective optical recording mediums to convert the received light beams into electrical signals; wherein the optical pickup further includes
optical axis combining means arranged on a light path from the light source to the light receiving means for bringing the optical axes of the reflected light beams of the first to third light beams into coincidence on a light receiving surface of the light receiving means.

According to the present invention, there is provided a recording and/or reproducing apparatus for an optical recording medium adapted for rotationally driving each of a plurality of optical recording mediums having different protective substrate thicknesses, the apparatus including an optical pickup displaced along the radius of the optical recording mediums by feed means for carrying out recording and/or reproduction by a plurality of light beams having different wavelengths and numerical apertures, depending on the sort of the optical recording mediums, the apparatus controlling the rotation of the optical recording mediums and the displacement of the optical pickup in keeping with the recording and/or reproducing operation, wherein the optical pickup includes
a light source for radiating a first light beam having a first wavelength, a second light beam having a second wavelength and a third light beam having a third wavelength, from different positions of a single package;
an objective lens for condensing the first to third light beams on the optical recording mediums having respective different protective substrate thicknesses; and
light receiving means for receiving the light beams reflected back from the respective optical recording mediums to convert the received light beams into electrical signals; wherein the optical pickup further includes
optical axis combining means arranged on a light path from the light source to the light receiving means for bringing the optical axes of reflected light beams of the first to third light beams into coincidence on a light receiving surface of the light receiving means.

According to the present invention, the light spots of the recording and/or reproducing light beams of different wavelengths, radiated from plural light sources, may be combined in the same area, and the laser light beams of the respective light sources may be received by sole light receiving means. In case optical axis combining means are provided on the forward light path to combine the optical axes of the light beams from plural different light sources, it is possible to alleviate adverse effects otherwise caused by off-axis characteristics of e.g. an objective lens.

### BRIEF DESCRIPTION OF THE DRAWINGS

FIG. 1 illustrates an optical system of an optical pickup shown as a first embodiment of the present invention.

FIG. 2 illustrates positioning of laser devices provided to a light source unit of the optical pickup.

FIGS. 3a and 3b illustrate a wedge-shaped prism and a stepped light deflecting optical device, respectively.

FIG. 4 illustrates an optical system of an optical pickup shown as a second embodiment of the present invention.

FIG. 5a illustrates positioning of laser devices provided to a light source unit of the optical pickup and FIGS. 5b, 5c illustrate how a light beam has its optical axis displaced by a wedge-shaped prism to form an image at the same position.

FIG. 6 illustrates an optical system of an optical pickup shown as a third embodiment of the present invention.

FIG. 7a illustrates positioning of laser devices provided to a light source unit of the optical pickup and FIGS. 7b, 7c illustrate how a light beam has its optical axis displaced by a wedge-shaped prism to form an image at the same position.

FIG. 8 is a block diagram showing a recording and/or reproducing apparatus for an optical disc employing an optical pickup shown as an embodiment of the present invention.

### DESCRIPTION OF THE PREFERRED EMBODIMENTS

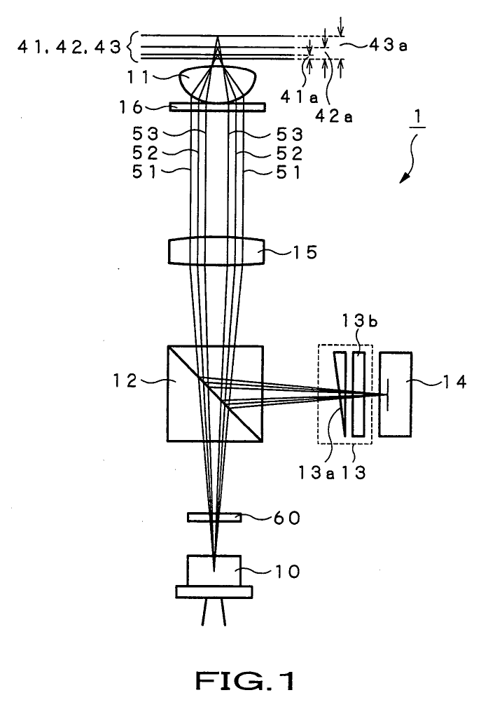

Referring to the drawings, certain present embodiments of the present invention will now be explained in detail. First, an optical system of an optical pickup, shown as a first embodiment of the present invention, will be explained with reference to FIG. 1. In this first embodiment, plural light sources are juxtaposed on a straight line.

The present embodiment is directed, as an example, to an optical pickup having a three wavelength compatible optical system for a first optical disc 41 which is a Blue-Ray disc (BD) employing a light beam 51 with a wavelength of 405 nm, a second optical disc 42 which is a Digital Versatile Disc (DVD) employing a light beam 52 with a wavelength of 655 nm, and a third optical disc 43 which is a Compact Disc (CD) employing a light beam 53 with a wavelength of 785 nm.

An optical pickup 1 comprises an optical system including a light source unit 10 for radiating light beams of different wavelengths, an objective lens 11 for condensing the light beams from the light source unit 10 on a recording surface of the optical disc, a beam splitter 12 for separating the light beam from the light source unit 10 and a light beam reflected back from the recording surface of the optical disc, an optical axis combining unit 13 for combining the optical axes of respective light beams, and a common photodetector 14 for detecting the reflected light from the first optical disc 41, that from the second optical disc 42 and that from the third optical disc 43. The optical system is configured for combining three laser light paths from three laser devices 10a, 10b and 10c, provided on the light source unit 10 for illuminating respective light beams on the recording surfaces of the BD, DVD and the CD by the same objective lens 11 and for condensing the light beams reflected back from the recording surfaces on a light receiving surface of the common photodetector.

The light source unit 10 is a so-called three-wavelength laser diode, referred to below as a three-beam LD, in a sole package of which are housed a light source for a recording and/or reproducing light beam for BD, a light source for a recording and/or reproducing light beam for DVD and a light source for a recording and/or reproducing light beam for CD. Specifically, the light source unit is made up by a first laser device 10a, a second laser device 10b and a third laser device 10c. The first laser device 10a radiates a light beam 51 of a wavelength of 405 nm, as a first wavelength, for recording and/or reproducing the BD. The second laser device 10b radiates a light beam 52 of a wavelength of 655 nm, as a second wavelength, for recording and/or reproducing the DVD, and the third laser device 10c radiates a light beam 53 of a wavelength of 785 nm, as a third wavelength, for recording and/or reproducing the CD.

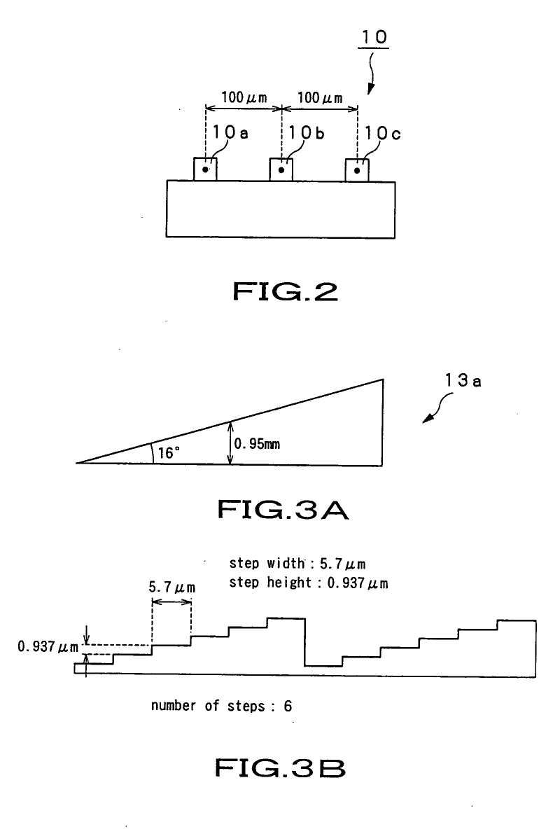

The light source unit 10 is shown schematically in FIG. 2. The light source unit 10 includes three light sources, comprised of the first laser device 10a, second laser device 10b and the third laser device 10c, juxtaposed at an interval of 100 μm from one another, as shown in FIG. 2.

The objective lens 11 is able to condense the light beams 51, 52 and 53 on the BD having a first protective substrate thickness 41a, on the DVD having a second protective substrate thickness 42a and on the CD having a third protective substrate thickness 43a, respectively. In the present embodiment, the numerical aperture of the objective lens 11 is 0.85, 0.60 and 0.45 for the first, second and third wavelengths, respectively. The first protective substrate thickness of the first optical disc as the BD is 0.1 mm, while that of the second optical disc as the DVD is 0.6 mm and that of the third optical disc as the CD is 1.2 mm.

The beam splitter 12 causes the reflected light from the optical disc to branch from the return light path proceeding to the three-beam LD 10, and is arranged at an angle of 45° relative to the optical axis.

The optical axis combining unit 13 is made up by a wedge-shaped prism 13a, having a light incident surface for the reflected light beam inclined with respect to the optical axis, and by a stepped light deflecting optical device (hologram device) 13b, having a stepped profile of the cross-section parallel to the transmitting optical axis. The optical characteristics of the wedge-shaped prism 13a is such that, by taking advantage of the differential optical axis angle variations of the transmitted light beam, caused with difference in the wavelengths, the light condensing position of the light spots of the reflected light is offset such as to cause the optical axes of the light beams from two of the first to three light sources to be confounded on the light receiving surface of the photodetector by an optical axis combining action. The stepped light deflecting optical device 13b is adapted for bringing the optical axis of the light beam radiated from the remaining one of the first to third light sources into coincidence with the optical axis combined by the wedge-shaped prism 13a.

The wedge-shaped prism 13a and the stepped light deflecting optical device 13b are shown schematically in FIG. 3. The wedge-shaped prism 13a has a wedge angle of 16° and a thickness at a mid point of 0.95 mm, and is formed of a prism glass material BK7, as shown in FIG. 13a. The stepped light deflecting optical device 13b has six steps, with a step width being 5.71 μm and with a step height being 0.937 μm, as shown in FIG. 13b. The optical axis combining unit 13, made up by the wedge-shaped prism 13a and the stepped light deflecting optical device 13b, generates an order-zero diffracted light beam for the light beam 51 for BD, having a wavelength of 405 nm, while generating an order-minus-one diffracted light beam for the light beam 52 for DVD, having a wavelength of 655 nm and generating an order-zero diffracted light beam for the light beam 53 for CD, having a wavelength of 785 nm. The diffraction efficiency is 79%, 77% and 68% for the order-zero diffracted light of the light beam 51, the order-minus-one diffracted light of the light beam 52 and for the order-zero diffracted light of the light beam 53, respectively.

In the optical pickup 1, having the optical system, described above, the light beams radiated from the three-beam LD 10 are transmitted through the beam splitter 12. When transmitted through a collimator lens 15, the light beams are collimated to fall on the objective lens 11. The light beams, reflected by the recording surface, are transmitted through the objective lens 11 and the collimator lens 15 to get to the beam splitter 12, by which the beams are reflected and thence transmitted through the optical axis combining unit 13, made up by the wedge-shaped prism 13a and the stepped light deflecting optical device 13b, to then get to the photodetector 14.

With the return light path length of the order of 20 mm, reflected light spots are formed on the light receiving surface of the photodetector 14, with the interval between the light spots being approximately equal to the interval between the laser devices, in the absence of the optical axis combining unit 13. In the present embodiment, the optical axis combining unit 13 is interposed on the light path to diffract the light beams such that the imaging positions of the light beams 51 to 53 on the photodetector are overlapped in substantially the same area. In general, the angle of diffraction of light in a medium is smaller the smaller the wavelength. In addition, the amount of diffraction of the light beam may be adjusted by proper selection of the thickness, wedge angle, material type (refractive index) and the position in the light path, of the wedge-shaped prism, such that it is possible to absorb the imaging position deviations of the first laser device 10a and the third laser device 10c with respect to the second laser device 10b in the light source unit 10 shown in FIG. 2.

When passing through the wedge-shaped prism 13a, the light beam 51, with the waveform of 405 nm, is offset by approximately 1.35 mm on a plane which is the same as a light receiving surface of the photodetector 14. Similarly, when passing through the wedge-shaped prism 13a, the light beam 53, with the wavelength of 785 nm, is offset by approximately 1.35 mm along the same direction as the light beam 51 and, when passing through the wedge-shaped prism 13a, the light beam 52, with the waveform of 655 nm, is offset by approximately 1.42 mm along the same direction as the light beam 51. The result is that the imaging positions of the light beams 51, 53 may be overlapped with each other at approximately the same location. In addition, by diffracting the light beam 52 (wavelength of 655 nm) by the stepped light deflecting optical device 13b, the imaging position of the light beam 52 may be made to coincide with those of the light beams 51, 53.

The first light beam 51, radiated from the first laser device 10a of the three-beam LD 10, the second light beam 52, radiated from the second laser device 10b and the third light beam 53, radiated from the third laser device 10c, are transmitted through the beam splitter 12 and the collimator lens 15 to fall on the objective lens 11. By this objective lens 11, the light beams 51 to 53 are condensed on the signal recording surfaces of the optical discs 41 to 43, respectively. The reflected light beams from the signal recording surfaces of the optical discs own information signals recorded on the signal recording surfaces and are returned through the objective lens 11 and the collimator lens 15 to the beam splitter 12. These reflected light beams are reflected by the beam splitter 12 and thereby deflected by 90°. These light beams are then transmitted through the optical axis combining unit 13 so as to be condensed on the light receiving surface of the same photodetector 14.

When passing through the beam splitter 12, the reflected light beams are subjected to astigmatism. This astigmatism is used in the so-called astigmatic method for detecting focusing error signals. On the other hand, the light beams 51 to 53 may each be split by a diffractive device 60 into at least three light beams (order-zero light, order-one light and order-minus-one light) for tracking detection. Meanwhile, in the present optical pickup 1, tracking servo may be detected by the so-called DPP method or by the DPD method, depending on the sorts of the light beams. The optical pickup 1 includes a part for detection tracking error signals and a part for detecting focusing error signals, in a manner not shown.

Meanwhile, since the thickness of the protective substrate, protecting the recording surfaces of the optical discs, differ from one disc to another, spherical aberration is produced, depending on the difference in the protective substrates, in case the same optical system is used for the light beams with different wavelengths. Thus, in the present embodiment, a correction device 16 for correcting the spherical aberration, generated by the difference in the protective substrate thicknesses, is provided directly forward of the light source side of the objective lens 11. In this case, the correction device 16 may simultaneously be used for limiting the aperture of the light beams.

In the above-described embodiment, the optical axis combining unit 13 is provided on the return path. However, the optical axis combining unit may also be provided on the forward path between the light source and the recording surface of the optical recording medium. One of the wedge-shaped prism 13a and the stepped light deflecting optical device 13b, making up the optical axis combining unit 13, may be provided on the forward path, with the remaining one being provided on the return path. Each one pair of the wedge-shaped prism 13a and the stepped light deflecting optical device 13b may be provided on the forward and return paths. In particular, it is efficacious to provide the optical axis combining unit on the forward path since it is then possible to moderate the adverse effects otherwise caused by off-axis characteristics of e.g. an objective lens.

With the optical pickup 1, shown as the first embodiment, it is possible to cause light spots of reflected light of light beams of different wavelengths, radiated from different light emitting points, to be confounded on the same light receiving surface of the same photodetector, by way of the optical axis combining operation, despite the fact that such was not possible to achieve with the conventional system.

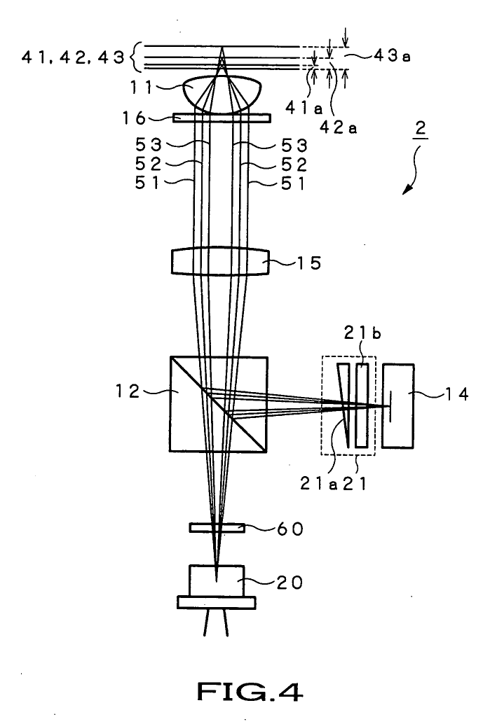

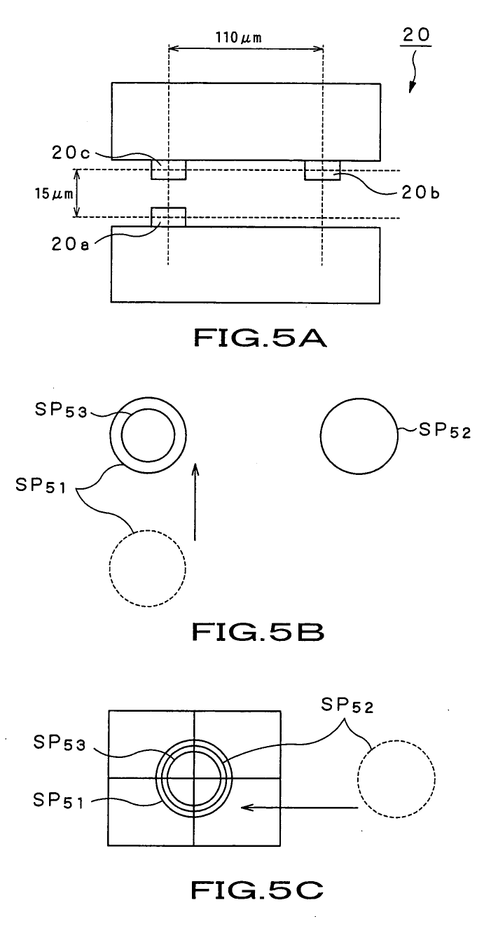

In a specified embodiment, now explained, plural light sources are not arranged on one and the same straight line. This may be coped with by different configurations, depending on the sorts of the light beams to be diffracted. Referring to FIG. 4, an optical system of the optical pickup 2, shown as a second embodiment, will now be explained. In the second embodiment, three light sources are not on a straight line and the optical axes of the reflected light of the light beam 51 for the BD and the reflected light of the light beam 52 for DVD are made to coincide with the optical axis of the reflected light of the light beam 53 for CD. The parts or components which are the same as those shown in FIG. 1 are depicted by the same reference numerals and detailed description is omitted for simplicity.

An optical pickup 2 comprises an optical system including a light source unit 20 for radiating light beams of different wavelengths, an objective lens 11 for condensing the light beams from the light source unit 20 on a recording surface of the optical disc, a beam splitter 12 for separating the light beam from the light source unit 20 and a light beam reflected back from the recording surface of the optical disc from each other, an optical axis combining unit 21 for combining the optical axes of respective light beams, and a common photodetector 14 for detecting the reflected light by the first optical disc 41, that by the second optical disc 42 and that by the third optical disc 43. The optical system is configured for combining three laser light paths from three laser devices 20a, 20b and 20c, provided on the light source unit 20, for illuminating respective light beams on the recording surfaces of the BD, DVD and the CD by the same objective lens 11, and for condensing the light beams reflected back from the recording surfaces on a light receiving surface of the common photodetector.

The light source unit 20 is a so-called three-wavelength laser diode, referred to below as a three-beam LD, in a sole package of which are housed light sources for the recording and/or reproducing light beams for the BD, DVD and CD. Specifically, the light source unit is made up by a first laser device 20a, a second laser device 20b and a third laser device 20c. The first laser device 20a radiates a light beam 51 of a wavelength of 405 nm, as a first wavelength, for recording and/or reproducing the BD. The second laser device 20b radiates a light beam 52 of a wavelength of 655 nm, as a second wavelength, for recording and/or reproducing the DVD, and the third laser device 20c radiates a light beam 53 of a wavelength of 785 nm, as a third wavelength, for recording and/or reproducing the CD.

The light source unit 20, used in the present embodiment, is shown schematically in FIG. 5a. The light source unit 20 includes three light sources, comprised of the second laser device 20b and the third laser device 20c are arranged on the same unit, at a spacing of 110 μm from each other, and a light source unit of the first laser device 20a is arranged at a spacing of 15 μm, as shown in FIG. 5a.

The optical axis combining unit 21 is made up by a wedge-shaped prism 21a, having an incident surface for the reflected light beam inclined relative to the optical axis, and a stepped light deflecting optical device 21b having a stepped profile of the cross-section parallel to the axis of light transmission. The angle of the optical axis, displaced by light transmission through the wedge-shaped prism, is smaller than that by the diffractive element. Hence, a wedge-shaped prism is preferably used for combining the optical axes radiated from light sources spaced apart from each other by a smaller distance. In the present embodiment, the light beam 51 for BD, having a wavelength of 405 nm, is combined to a spot from the light beam for CD, having a wavelength of 785 nm, by deflection of the angle of the optical axis produced on light beam transmission through the wedge-shaped prism, and the light beam 52 for DVD, having the wavelength of 655 nm, is made to coincide with the imaging position of the light beams 51 and 53, by the stepped light deflecting optical device 21b. This state is shown in FIGS. 5b and 5c. It is assumed that, in case the light source unit 20 is arranged as shown in FIG. 5a, and the optical axis combining unit 21 is not used, a light spot of reflected light SP51 of the light beam 51, a light spot of reflected light SP52 of the light beam 52 and a light spot of reflected light SP53 of the light beam 53 are condensed on the light receiving surface of the photodetector 14, as shown in FIG. 5b.

In this case, the light spot SP51 is combined with the imaging position of the light spot SP53 of the reflected light of the light beam 53 by optical characteristics of the wedge-shaped prism 21a, while the light beam 52 is displaced, by the stepped light deflecting optical device 21b, so that the light spot SP52 of the light beam 52 for DVD will be combined with the light spot SP53 at the imaging location thereof, as shown schematically in FIG. 5c.

Thus, with the optical pickup 2, shown as the second embodiment, the light spots of reflected light beams of different wavelengths, radiated from different light radiating points, may be combined on the same light receiving surface of the photodetector.

In the above-described second embodiment, the optical axis combining unit 21 may also be provided on the forward path between the light source and the recording surface of the optical recording medium. One of the wedge-shaped prism 21a and the stepped light deflecting optical device 21b, making up the optical axis combining unit 21, may be provided on the forward path, with the remaining one being provided on the return light path. Each one pair of the wedge-shaped prism 21a and the stepped light deflecting optical device 21b may also be provided on the forward and return light paths. In particular, it is efficacious to provide the optical axis combining unit on the forward light path because this moderates the adverse effects otherwise caused by off-axis characteristics of e.g. an objective lens.

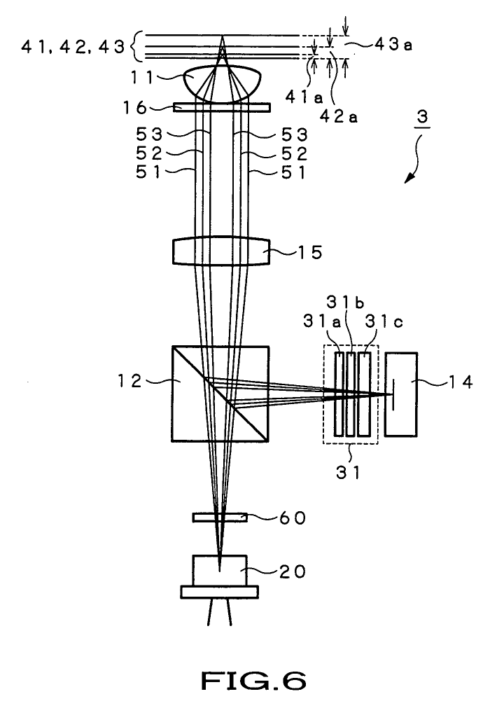

Referring to FIG. 6, an optical system of an optical pickup 3, as a third embodiment, will now be explained. In this third embodiment, the aforementioned second problem is solved by separating the laser light of the wavelength of 405 nm and the laser light of the wavelength of 785 nm are separated from each other by light polarization. The parts or components which are the same as those shown in FIG. 1 are depicted by the same reference numerals and detailed description is omitted for simplicity. A light source for the optical pickup 3 used is the same as the light source unit 20 of the optical pickup 2.

An optical axis combining unit 31 includes an element for causing rotation of the direction of polarization of one of the first light beam 51, second light beam 52 and the third light beam 53, by 90°, a first diffractive means for bringing the optical axis of the rotated light beam into coincidence with the optical axis of one of the remaining light beams, and a second diffractive means for bringing the optical axis of the remaining light beam into coincidence with the optical axis formed by the first diffractive element. In the present embodiment, the optical axis combining unit 31 is made up by a λ/4 plate 31a, acting only on the light beam 53 for CD, with a wavelength of 785 nm, a polarization dependent diffractive device 31b, diffracting only the light beam 53, having polarization rotated by the λ/4 plate 31a, and a diffractive device 31c producing light diffraction for bringing the optical axis of the light beam 52 for DVD into coincidence with the light spot of the reflected light of the light beam 51 for BD.

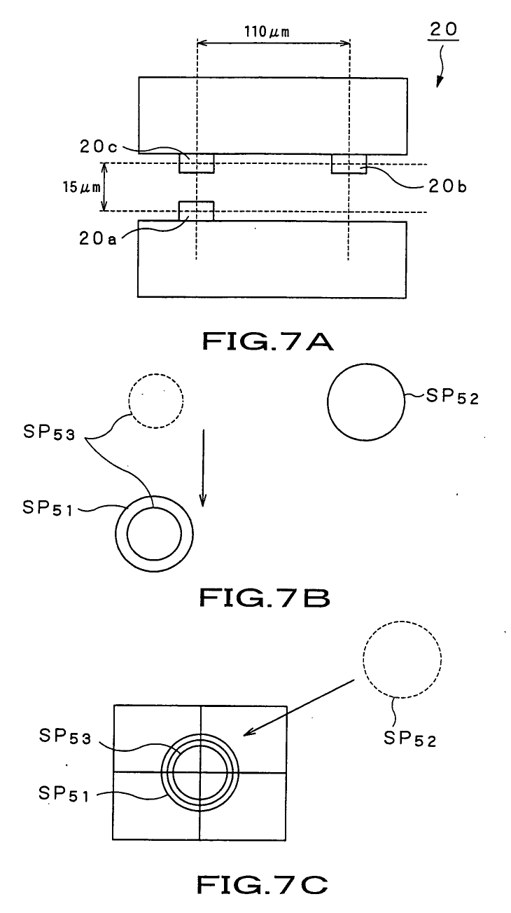

In the present embodiment, the light beam 53 for CD, having the wavelength of 785 nm, is combined with the light spot of the reflected light of the light beam 51 for BD, having the wavelength of 405 nm, by the λ/4 plate 31a and the polarization dependent diffractive device 31b, whilst the light beam 52 for DVD, having the wavelength of 655 nm, is brought into coincidence with the imaging location of the light beams 51 and 53. This state is shown in FIGS. 7b and 7c. It is assumed that, in case the light source unit 20 is arranged as shown in FIG. 5a, and the optical axis combining unit 31 is not used, a light spot of reflected light SP51 of the light beam 51, a light spot of reflected light SP52 of the light beam 52 and a light spot of reflected light SP53 of the light beam 53 are condensed on the light receiving surface of the photodetector 14, as shown in FIG. 7b.

In this case, as shown schematically in FIG. 7c, the light spot SP53 is combined with the imaging location of the light spot SP51 of the reflected light of the light beam 51, by optical characteristics of the λ/4 plate 31a and the polarization dependent diffractive device 31b, while the light beam 52 is displaced, by the diffractive element 31c, so that the light spot SP52 of the light beam 52 for DVD is combined with the imaging location of the light spot SP53.

Thus, with the optical pickup 2, shown as the third embodiment, the light spots of reflected light beams of different wavelengths, radiated from different light radiating points, may be combined on the same light receiving surface of the photodetector.

In the above-described third embodiment, the optical axis combining unit 31 may also be provided on the forward path between the light source and the recording surface of the optical recording medium. The λ/4 plate 31a and the polarization dependent diffractive device 31b, making up the optical axis combining unit 31, may be provided on the forward light path, with the diffractive device 31c being provided on the return light path. Each one pair of the optical axis combining unit 31 may be provided on the forward and return light paths. In particular, it is efficacious to provide the optical axis combining unit on the forward light path in view of the possibility of moderating the adverse effects otherwise produced by off-axis characteristics of e.g. an objective lens.

The above-described first to third embodiments are featured by the configuration of combining the optical axes of three laser light beams having different wavelengths. The specified structure may, however, be changed without departing from the scope of the invention. For example, the light paths may be designed so that the optical axes are folded partway using an uplift mirror.

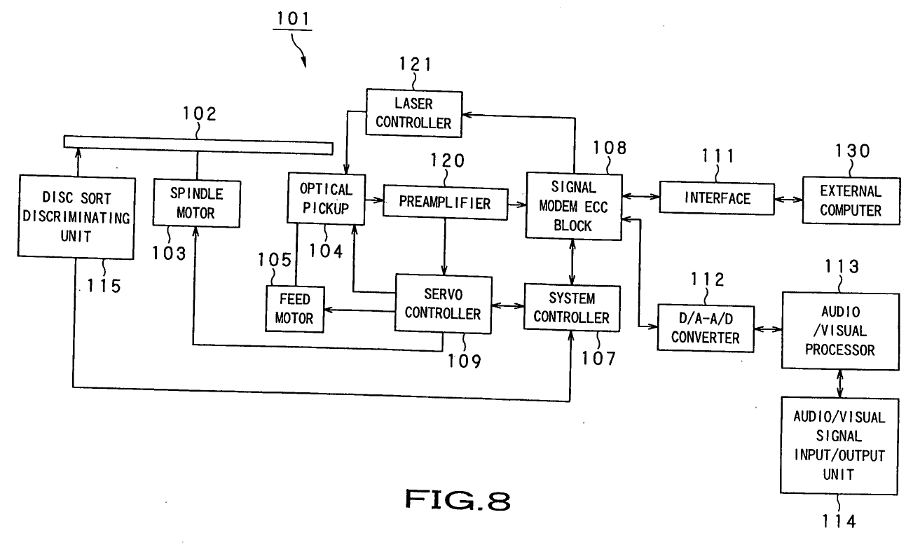

FIG. 8 shows a recording and/or reproducing apparatus 101 for an optical disc in which an optical pickup embodying the present invention.

The recording and/or reproducing apparatus 101 includes a spindle motor 103, as means for rotationally driving an optical disc 102, as an optical recording medium, an optical pickup 104, according to the present invention, and a feed motor 105, as driving means therefor. The present recording and/or reproducing apparatus 101 provides for three standard compatibility for recording and/or reproducing three different types of the optical disc 102 having different formats.

The optical discs usable in the present embodiment include a BD, employing a light beam of a wavelength of 405 nm, as recording and/or reproducing light, a DVD employing a light beam of a wavelength of 655 nm and a CD employing a light beam of a wavelength of 785 nm. The optical discs 41 to 43 correspond to the optical disc 102 of FIG. 8.

The spindle motor 103 and the feed motor 105 are driven, in dependence upon disc sorts, by a servo controller 109, controlled under a command from a system controller 107, also operating as disc sort discriminating means. For example, the spindle motor 103 and the feed motor 105 are each driven at a preset rpm, depending on whether the disc to be driven is the optical disc 41, optical disc 42 or the optical disc 43.

The optical pickup 104 is an optical pickup having a three wavelength compatible optical system, explained with reference to FIGS. 1, 4 and 6. The optical pickup 104 radiates light beams of different wavelengths to the recording layers of the optical discs of different standards, while detecting the light beams reflected from the recording layers of the optical discs. The optical pickup sends signals corresponding to the light beams, from the reflected light beams as detected, to a preamplifier 120.

An output of the preamplifier 120 is sent to a signal modem and error correction coding block, referred to below as a signal modem ECC block 108. This signal modem ECC block 108 modulates/demodulates signals and appends ECC (error correction codes). The optical pickup 104 illuminates a light beam on a recording layer of the optical disc 102, rotated under a command of the signal modem ECC block 108, for recording and/or reproducing signals for the optical disc 102.

The preamplifier 120 is configured for generating focusing error signals, tracking error signals and RF signals, for example, based on signals corresponding to detected light beams differing from one format to another. Depending on the sorts of the optical recording mediums, to be recorded and/or reproduced, preset processing, such as demodulation or error correction, is carried out based on standards for BD, DVD and CD, by e.g. the servo controller 109 or the signal modem ECC block 108.

In case the recorded signals, demodulated by the signal modem ECC block 108, are those for storage on a computer, the signals are sent over an interface 111 to an external computer 130. This enables e.g. the external computer 130 to receive signals recorded on the optical disc 102 as reproduced signals.

In case the recorded signals, demodulated by the signal modem ECC block 108, are those for audio/visual use, the signals are digital-to-analog converted by a D/A converter of a D/A-A/D converter 112, and the resulting signals are sent to an audio/visual processor 113, so as to be subjected to audio/visual processing. The resultant signals are sent via an audio/visual signal input/output unit 114 to, for example, an external imaging/projecting device, not shown.

In the optical pickup 104, control of the feed motor 105 for causing movement of the optical pickup to a preset recording track on the optical disc 102, control of the spindle motor 103 and driving control along the focusing and tracking directions of a biaxial actuator, holding an objective lens, operating as light condensing means in the optical pickup 104, are taken charge of by the servo controller 109.

The servo controller 109 actuates an optical coupling efficiency varying element, provided in the optical pickup 104, to exercise control so that the optical coupling efficiency in the optical pickup 104, that is, the ratio of the volume of light condensed on the optical disc 102 to the total volume of the light beam radiated from the laser light source, such as a semiconductor laser device, will be varied in dependence upon the prevailing operating mode, that is, the recording mode or the reproducing mode, or the sort of the optical disc 102.

A laser controller 121 controls the laser light source of the optical pickup 104. In particular, in the present embodiment, the laser controller 121 exercises control for varying the output power of the laser light source depending on whether the operating mode is the recording mode or the reproducing mode. The laser controller also exercises control for varying an output power of the laser light source depending on the sort of the optical disc 102. The laser controller 121 also switches the laser light sources of the optical pickup 104 depending on the sort of the optical disc 102 as detected by a disc sort discriminating unit 115.

The disc sort discriminating unit 115 is able to detect the different formats of the optical disc 102 from e.g. surface reflectivity or difference in shape among BD, DVD and CD. The blocks of the recording and/or reproducing apparatus 101 are designed and constructed for performing signal processing, based on detected results in the disc sort discriminating unit 115, depending on the results of detection by the disc sort discriminating unit 115.

The system controller 107 discriminates the sort of the optical disc 102 based on the results of detection sent from the disc sort discriminating unit 115. If the optical recording medium is of the type accommodated in a cartridge, such a technique of providing a detection hole in the cartridge and detecting the hole using a contact detection switch or a push switch may be used for discriminating the sort of the optical recording medium.

The servo controller 109, operating as optical coupling controlling means, controls the optical coupling efficiency in the optical pickup 104, depending on the results of detection by the disc sort discriminating unit 115, under control by the system controller 107. The servo controller 109 is able to discriminate the recording area to be recorded and/or reproduced, by detecting the relative position between the optical pickup 104 and the optical disc 102. The relative position may also be detected based on an address signal recorded on the optical disc 102. The servo controller 109 controls the optical coupling efficiency in the optical pickup 104 responsive to the results of discrimination of the recording area to be recorded and/or reproduced.

With the optical disc recording and/or reproducing apparatus 101, employing optical pickups of the first to third embodiments, light beam of different wavelengths, generated by plural light sources, and reflected from the recording surface, may be combined at the same area, so that the laser light beams from the different light sources may be received by a sole photodetector.

The present invention may be applied to disc formats different from those explained in the embodiments, provided that the optical pickup is such a one recording and/or reproducing optical recording mediums having different protective substrate thicknesses. For example, the optical disc may be any of recording and/or reproducing discs of various systems employing optical modulation recording, optical discs, including magneto-optical discs, phase change recording discs or dye recording discs, more specifically, any of a large variety of photo-magnetic recording mediums, including ‘CD-R/RW’, ‘DVD-RAM’, ‘DVD-R/RW’ or ‘DVD+RW’. The optical disc may be such a disc the recording layer of which is divided into at least two recording areas having different optimum recording and/or reproducing light power values, or such a disc including plural recording layers deposited together via transparent substrates.

It should be understood by those skilled in the art that various modifications, combinations sub-combinations and alterations may occur depending on design requirements and other factors insofar as they are within the scope of the appended claims or the equivalents thereof.

1. An optical pickup for recording and/or reproducing each of a plurality of optical recording mediums having different protective substrate thicknesses, by light beams different in wavelength and in numerical aperture, said optical pickup comprising
a light source including a first radiating part for radiating a first light beam having a first wavelength, a second radiating part for radiating a second light beam having a second wavelength, and a third radiating part for radiating a third light beam having a third wavelength,
an objective lens for condensing said first to third light beams on each of the optical recording mediums having different protective substrate thicknesses, and
light receiving means for receiving light beams reflected by said optical recording mediums and converting the light beams into electrical signals,
there being provided optical axis combining means on an light path from a light source to said light receiving means for bringing the optical axes of reflected light beams of said first to third light beams into coincidence on a light receiving surface of said light receiving means.

2. The optical pickup according to claim 1 wherein said optical axis combining means include
a first diffractive element for combining the optical axes of two light beams radiated from two out of said first to third radiating units; and
a second diffractive element for bringing the optical axis of the light beam radiated from the remaining radiating unit out of said first to third radiating units into coincidence with an optical axis formed by the combining operation by said first diffraction means.

3. The optical pickup according to claim 2 wherein, in said optical axis combining means, one of the diffractive elements is a wedge-shaped prism, the light incident surface of which for said reflected light beam is inclined relative the optical axis of said light beam, and wherein the remaining diffractive element is a stepped light deflecting optical element.

4. The optical pickup according to claim 1 wherein said optical axis combining means include
polarization direction rotating means for rotating the direction of polarization of one of said first to third light beams through 90°,
first diffraction means for bringing the optical axis of the light beam, rotated by said polarization direction rotating means, into coincidence with the optical axes of the light beams other than said one light beam; and
second diffraction means for bringing the optical axis of the remaining light beam into coincidence with the optical axis formed by said first diffraction means.

5. A recording and/or reproducing apparatus for an optical recording medium for rotationally driving each of a plurality of optical recording mediums having different protective substrate thicknesses, said apparatus including an optical pickup displaced along the radius of said optical recording mediums by feed means for carrying out recording and/or reproduction by a plurality of light beams having different wavelengths and numerical apertures depending on the sort of the optical recording mediums, said apparatus controlling the rotation of the optical recording mediums and the displacement of the optical pickup in keeping with the recording and/or reproducing operation, wherein said optical pickup comprises
a light source including a first radiating part for radiating a first light beam having a first wavelength, a second radiating part for radiating a second light beam having a second wavelength, and a third radiating part for radiating a third light beam having a third wavelength mounted in proximity to one another;
an objective lens for condensing said first to third light beams on each of the optical recording mediums having different protective substrate thicknesses; and
light receiving means for receiving light beams reflected by said optical recording mediums and converting the light beams into electrical signals,
there being provided optical axis combining means on a light path from a light source to said light receiving means for bringing the optical axes of reflected light beams of said first to third light beams into coincidence on a light receiving surface of said light receiving means.

6. The recording and/or reproducing apparatus for an optical recording medium according to claim 5 wherein said optical axis combining means include
a first diffractive element for combining optical axes of light beams, radiated from two of said first to third radiating units; and
a second diffractive element for bringing the optical axis of the light beam, radiated from the remaining one of said first to third radiating units, into coincidence with the optical axis formed by optical axis combining action by said first diffractive element.

7. The recording and/or reproducing apparatus for an optical recording medium according to claim 6 wherein, in said optical axis combining means, one of the diffractive elements is a prism having a wedge shape with a surface thereof on which falls the reflected light beam is inclined relative to the optical axis of said light beam; and wherein
the other diffractive element is a stepped light deflecting optical element.

8. The recording and/or reproducing apparatus for an optical recording medium according to claim 5 wherein said optical axis combining means in said optical pickup includes
polarization direction rotating means for rotating the direction of polarization of one of said first to third light beams through 90°;
first diffraction means for bringing the optical axis of the light beam, rotated by said polarization direction rotating means, into coincidence with the optical axis of one of the remaining light beams; and
second diffractive means for bringing the optical axis of the remaining light beam into coincidence with the optical axis formed by said first diffraction means.

9. An optical pickup for recording and/or reproducing a plurality of optical recording mediums, having different protective substrate thicknesses, using light beams having different wavelengths and numerical apertures, said optical pickup comprising
a light source for radiating a first light beam having a first wavelength, a second light beam having a second wavelength and a third light beam having a third wavelength, from different positions of a single package;
an objective lens for condensing said first to third light beams on said optical recording mediums having respective different protective substrate thicknesses; and
light receiving means for receiving the light beams reflected back from the respective optical recording mediums to convert the received light beams into electrical signals; wherein the optical pickup further comprises
optical axis combining means arranged on a light path from said light source to said light receiving means for bringing the optical axes of the reflected light beams of said first to third light beams into coincidence on a light receiving surface of said light receiving means.

10. The optical pickup according to claim 9 wherein said optical axis combining means includes
first diffractive means for combining the optical axes of two of said first to third light beams; and
second diffractive means for bringing the optical axis of the remaining one of said first to third light beams into coincidence with the optical axis formed by the optical axis combining action by said first diffractive element.

11. The optical pickup according to claim 10 wherein said optical axis combining means includes
a prism having a wedge shape with a surface thereof on which falls the reflected light beam is inclined relative to the optical axis of said light beam; and wherein
the other diffractive element is a stepped light deflecting optical element.

12. The recording and/or reproducing apparatus for an optical recording medium according to claim 7 wherein said optical axis combining means in said optical pickup includes
a polarization direction rotating device for rotating the direction of polarization of one of said first to third light beams through 90°;
a first diffraction device for bringing the optical axis of the light beam, rotated by said polarization direction rotating device, into coincidence with the optical axis of one of the remaining light beams; and
a second diffractive device for bringing the optical axis of the remaining light beam into coincidence with the optical axis formed by said first diffraction device.

13. A recording and/or reproducing apparatus for an optical recording medium adapted for rotationally driving each of a plurality of optical recording mediums having different protective substrate thicknesses, said apparatus including an optical pickup displaced along the radius of said optical recording mediums by feed means for carrying out recording and/or reproduction by a plurality of light beams having different wavelengths and numerical apertures, depending on the sort of the optical recording mediums, said apparatus controlling the rotation of the optical recording mediums and the displacement of the optical pickup in keeping with the recording and/or reproducing operation, wherein said optical pickup comprises
a light source for radiating a first light beam having a first wavelength, a second light beam having a second wavelength and a third light beam having a third wavelength, from different positions of a single package;
an objective lens for condensing said first to third light beams on said optical recording mediums having respective different protective substrate thicknesses; and
light receiving means for receiving the light beams reflected back from the respective optical recording mediums to convert the received light beams into electrical signals; wherein the optical pickup further comprises
optical axis combining means arranged on a light path from said light source to said light receiving means for bringing the optical axes of reflected light beams of said first to third light beams into coincidence on a light receiving surface of said light receiving means.

14. The optical pickup according to claim 13 wherein said optical axis combining means includes
a first diffractive element for combining the optical axes of two of said first to third light beams; and
a second diffractive element for bringing the optical axis of the remaining one of said first to third light beams into coincidence with the optical axis formed by the optical axis combining action by said first diffractive element.

15. The optical pickup according to claim 14 wherein said optical axis combining means includes
a prism having a wedge shape having a surface thereof, on which falls the reflected light beam, inclined relative to the optical axis; and wherein
the other diffractive element is a stepped light deflecting optical element.

16. The recording and/or reproducing apparatus for an optical recording medium according to claim 10 wherein said optical axis combining means in said optical pickup includes
polarization direction rotating means for rotating the direction of polarization of one of said first to third light beams through 90°;
first diffraction means for bringing the optical axis of the light beam, rotated by said polarization direction rotating means, into coincidence with the optical axis of one of the remaining light beams; and
second diffractive means for bringing the optical axis of the remaining light beam into coincidence with the optical axis formed by said first diffraction means.

17. In an optical system in which at least a first light beam of a first wavelength, a second light beam of a second wavelength and a third light beam of a third wavelength are selectively radiated from a light source and illuminated via an objective lens to an optical recording medium and a light beam reflected back from the optical recording medium is received by a photodetector, an optical axis combining method comprising
a first step of combining optical axes of two of said first to third light beams; and
a second step of bringing the optical axis of the remaining one of said first to third light beams into coincidence with the optical axis formed by said first step.

18. An optical pickup for recording and/or reproducing each of a plurality of optical recording mediums having different protective substrate thicknesses, by light beams different in wavelength and in numerical aperture, said optical pickup comprising
a light source including a first radiating part for radiating a first light beam having a first wavelength, a second radiating part for radiating a second light beam having a second wavelength, and a third radiating part for radiating a third light beam having a third wavelength,
an objective lens for condensing said first to third light beams on each of the optical recording mediums having different protective substrate thicknesses, and
a light receiving section for receiving light beams reflected by said optical recording mediums and converting the light beams into electrical signals,
there being provided an optical axis combining section on an light path from a light source to said light receiving section for bringing the optical axes of reflected light beams of said first to third light beams into coincidence on a light receiving surface of said light receiving section.

19. A recording and/or reproducing apparatus for an optical recording medium for rotationally driving each of a plurality of optical recording mediums having different protective substrate thicknesses, said apparatus including an optical pickup displaced along the radius of said optical recording mediums by feed means for carrying out recording and/or reproduction by a plurality of light beams having different wavelengths and numerical apertures depending on the sort of the optical recording mediums, said apparatus controlling the rotation of the optical recording mediums and the displacement of the optical pickup in keeping with the recording and/or reproducing operation, wherein said optical pickup comprises
a light source including a first radiating part for radiating a first light beam having a first wavelength, a second radiating part for radiating a second light beam having a second wavelength, and a third radiating part for radiating a third light beam having a third wavelength mounted in proximity to one another;
an objective lens for condensing said first to third light beams on each of the optical recording mediums having different protective substrate thicknesses; and
a light receiving section for receiving light beams reflected by said optical recording mediums and converting the light beams into electrical signals,
there being provided an optical axis combining section on a light path from a light source to said light receiving section for bringing the optical axes of reflected light beams of said first to third light beams into coincidence on a light receiving surface of said light receiving section.

20. An optical pickup for recording and/or reproducing a plurality of optical recording mediums, having different protective substrate thicknesses, using light beams having different wavelengths and numerical apertures, said optical pickup comprising
a light source for radiating a first light beam having a first wavelength, a second light beam having a second wavelength and a third light beam having a third wavelength, from different positions of a single package;
an objective lens for condensing said first to third light beams on said optical recording mediums having respective different protective substrate thicknesses; and
a light receiving section for receiving the light beams reflected back from the respective optical recording mediums to convert the received light beams into electrical signals; wherein the optical pickup further comprises
an optical axis combining section arranged on a light path from said light source to said light receiving section for bringing the optical axes of the reflected light beams of said first to third light beams into coincidence on a light receiving surface of said light receiving section.

21. A recording and/or reproducing apparatus for an optical recording medium adapted for rotationally driving each of a plurality of optical recording mediums having different protective substrate thicknesses, said apparatus including an optical pickup displaced along the radius of said optical recording mediums by feed means for carrying out recording and/or reproduction by a plurality of light beams having different wavelengths and numerical apertures, depending on the sort of the optical recording mediums, said apparatus controlling the rotation of the optical recording mediums and the displacement of the optical pickup in keeping with the recording and/or reproducing operation, wherein said optical pickup comprises
a light source for radiating a first light beam having a first wavelength, a second light beam having a second wavelength and a third light beam having a third wavelength, from different positions of a single package;
an objective lens for condensing said first to third light beams on said optical recording mediums having respective different protective substrate thicknesses; and
a light receiving section for receiving the light beams reflected back from the respective optical recording mediums to convert the received light beams into electrical signals; wherein the optical pickup further comprises
an optical axis combining section arranged on a light path from said light source to said light receiving section for bringing the optical axes of reflected light beams of said first to third light beams into coincidence on a light receiving surface of said light receiving section.
